(19) United States
(12) Patent Application Publication
(10) Pub. No.: US 2026/0343147 A1
(43) Pub. Date: Oct. 29, 2026

(54) PORTABLE ELECTRONIC DEVICE AND SPEAKER MODULE

(71) Applicant: Acer Incorporated, New Taipei City (TW)

(72) Inventors: Po-Jen TU, New Taipei City (TW); Jia-Ren CHANG, New Taipei City (TW); Kai-Meng TZENG, New Taipei City (TW); Ming-Chun YU, New Taipei City (TW)

(21) Appl. No.: 19/243,927

(22) Filed: Jun. 20, 2025

(30) Foreign Application Priority Data
Aug. 30, 2024 (TW) 113132854

(51) Int. Cl. H04R 3/04

(52) U.S. Cl. CPC H04R 3/04; H04R 2499/15

(57) ABSTRACT

A speaker module includes a base, a first sound assembly, a first filter, a second sound assembly, and a second filter. The first sound assembly is disposed on the base and configured to emit a first sound. The first filter is connected to the first sound assembly and configured to adjust the frequency range of the first sound. The second sound assembly is disposed on the base and configured to emit a second sound. The second filter is connected to the second sound assembly and configured to adjust the phase difference between the second sound and the first sound. The first sound assembly and the second sound assembly are connected in parallel.

### CROSS REFERENCE TO RELATED APPLICATIONS

This application claims the benefit of Taiwan Patent Application No. 113132854, filed on Aug. 30, 2024, the entirety of which is incorporated by reference herein.

### BACKGROUND OF THE INVENTION

### Field of the Disclosure

The present disclosure relates to a portable electronic device and a speaker module, and in particular it relates to a portable electronic device and a speaker module capable of compensating for the phase difference between low-frequency sound and high-frequency sound.

### Description of the Related Art

As technology has developed, many of today's electronic devices (such as notebook computers) have become quite popular products. These notebook computers are among the most popular and widespread of today's consumer products. Users can execute various applications on notebook computers to achieve various purposes, such as watching videos, playing games, browsing the web, and reading e-books.

Generally speaking, electronic devices such as notebook computers are equipped with at least one speaker module configured to provide sound, such as music. In addition, a speaker module may have more than two driver units that can emit low-frequency and high-frequency sounds respectively. However, due to the lack of space inside the housing of a notebook computer, the size of the sound cavity of the speaker module is relatively small, which in turn affects the quality of the low-frequency sound emitted by the speaker module. In addition, there may be a phase difference between low-frequency sound and high-frequency sound when reaching the human ear, further reducing the level of performance of the sound output.

Therefore, how to design a speaker module that can increase the low-frequency sound effect and the overall output performance is a topic that needs to be discussed.

### BRIEF SUMMARY OF THE INVENTION

Accordingly, one objective of the present disclosure is to provide a speaker module to solve the above problems.

According to some embodiments of the disclosure, the present disclosure provides a speaker module includes a base, a first sound assembly, a first filter, a second sound assembly, and a second filter. The first sound assembly is disposed on the base and configured to emit a first sound. The first filter is connected to the first sound assembly and configured to adjust the frequency range of the first sound. The second sound assembly is disposed on the base and configured to emit a second sound. The second filter is connected to the second sound assembly and configured to adjust the phase difference between the second sound and the first sound. The first sound assembly and the second sound assembly are connected in parallel.

According to some embodiments, the first sound assembly includes a first speaker assembly and a second speaker assembly, and the second speaker assembly is symmetrical to the first speaker assembly. The second sound assembly includes a third speaker assembly and a fourth speaker assembly, and the fourth speaker assembly is symmetrical to the third speaker assembly.

According to some embodiments, the first speaker assembly and the second speaker assembly are arranged along a first axis, the third speaker assembly and the fourth speaker assembly are arranged along a second axis, and the first axis is perpendicular to the second axis.

According to some embodiments, the first filter, the first speaker assembly, and the second speaker assembly are electrically connected between a signal input node and a ground node, and the first filter includes a first capacitor and a first inductor. The first inductor has a first terminal and a second terminal, the first terminal of the first inductor is coupled to the signal input node, and the second terminal of the first inductor is coupled to a first node.

According to some embodiments, the first speaker assembly has a first terminal and a second terminal, the first terminal of the first speaker assembly is coupled to the first node, and the second terminal of the first speaker assembly is coupled to a second node. The second speaker assembly has a first terminal and a second terminal, the first terminal of the second speaker assembly is coupled to the second node, and the second terminal of the second speaker assembly is coupled to the ground node.

According to some embodiments, the first capacitor has a first terminal and a second terminal, the first terminal of the first capacitor is coupled to the first node, and the second terminal of the first capacitor is coupled to the ground node.

According to some embodiments, the first filter is a low-pass filter, and the cutoff frequency of the first filter is less than or equal to 1 kHz.

According to some embodiments, the second filter comprises a first impedance element to a fourth impedance element. The first impedance element has a first terminal and a second terminal, the first terminal of the first impedance element is coupled to the signal input node, and the second terminal of the first impedance element is coupled to a third node. The third speaker assembly has a first terminal and a second terminal, the first terminal of the third speaker assembly is coupled to the third node, and the second terminal of the third speaker assembly is coupled to a fourth node.

According to some embodiments, the fourth speaker assembly has a first terminal and a second terminal, the first terminal of the fourth speaker assembly is coupled to the fourth node, and the second terminal of the fourth speaker assembly is coupled to a fifth node. The second impedance element has a first terminal and a second terminal, the first terminal of the second impedance element is coupled to the fifth node, and the second terminal of the second impedance element is coupled to the ground node.

According to some embodiments, the third impedance element has a first terminal and a second terminal, the first terminal of the third impedance element is coupled to the signal input node, and the second terminal of the third impedance element is coupled to the fifth node. The fourth impedance element has a first terminal and a second terminal, the first terminal of the fourth impedance element is coupled to the third node, and the second terminal of the fourth impedance element is coupled to the ground node.

According to some embodiments, when the phase difference is less than 0, the first impedance element and the second impedance element are each configured to serve as a second inductor, and the third impedance element and the fourth impedance element are each configured to serve as a second capacitor. The values of the second inductor and the second capacitor are obtained using the following formula:

$$tan \frac{Δφ}{2} = - \frac{2 π \times {F}_{R}}{{ω}_{m}} \\ {ω}_{m} = \frac{1}{\sqrt{{L}_{2} {C}_{2}}} ;$$

Δφ is the phase difference, F_{R} is the reference frequency of the speaker module, ωₘ is the angular frequency of the second filter, C₂ is the capacitance value of the second capacitor, and L₂ is the inductance value of the second inductor.

According to some embodiments, the reference frequency is obtained using the following formula:

F_{R}=α×F_{LH}+(1−α)×F_{LPF}

F_{R} is the reference frequency, F_{LH} is the transitional frequency of the speaker module, F_{LPF} is the cutoff frequency of the first filter, and a is an adjustment coefficient, which is greater than 0 and less than 1.

According to some embodiments, the transitional frequency is obtained using the following formula:

$${F}_{LH} = \frac{{P}_{H}}{{P}_{L} + {P}_{H}} \times {F}_{L} + \frac{{P}_{L}}{{P}_{L} + {P}_{H}} \times {F}_{H}$$

F_{L} is a first resonant frequency of the first speaker assembly and the second speaker assembly, F_{H} is a second resonant frequency of the third speaker assembly and the fourth speaker assembly, P_{L} is the total power of the first speaker assembly and the second speaker assembly between the first resonant frequency and the second resonant frequency, and P_{H} is the total power of the third speaker assembly and the fourth speaker assembly between the first resonant frequency and the second resonant frequency.

According to some embodiments, when the phase difference is greater than 0, the first impedance element and the second impedance element are each configured to serve as a second capacitor, and the third impedance element and the fourth impedance element are each configured to serve as a second inductor. The values of the second inductor and the second capacitor are obtained using the following formula:

$$tan \frac{Δφ}{2} = - \frac{2 π \times {F}_{R}}{{ω}_{m}} \\ {ω}_{m} = \frac{1}{\sqrt{{L}_{2} {C}_{2}}}$$

Δφ is the phase difference, F_{R} is the reference frequency of the speaker module, ωₘ is the angular frequency of the second filter, C₂ is the capacitance value of the second capacitor, and L₂ is the inductance value of the second inductor.

According to some embodiments, the reference frequency is between the first resonant frequency and the cutoff frequency.

According to some embodiments of the disclosure, the present disclosure provides a portable electronic device which includes a housing and a speaker module. The speaker module is disposed in the housing and includes a base, a first sound assembly, a first filter, a second sound assembly, and a second filter. The first sound assembly is disposed on the base and configured to emit a first sound. The first filter is connected to the first sound assembly and configured to adjust the frequency range of the first sound. The second sound assembly is disposed on the base and configured to emit a second sound. The second filter is connected to the second sound assembly and configured to adjust the phase difference between the second sound and the first sound. The first sound assembly and the second sound assembly are connected in parallel.

According to some embodiments, the first sound assembly includes a first speaker assembly and a second speaker assembly, and the second speaker assembly is symmetrical to the first speaker assembly. The second sound assembly includes a third speaker assembly and a fourth speaker assembly, and the fourth speaker assembly is symmetrical to the third speaker assembly. A first sound outlet, a second sound outlet and a third sound outlet are formed on the housing, and the first sound outlet, the second sound outlet and the third sound outlet correspond to the first speaker assembly to the fourth speaker assembly.

According to some embodiments, sound generated by the first speaker assembly is output through the first sound outlet, sound generated by the second speaker assembly is output through the second sound outlet, sound generated by the fourth speaker assembly is output through the third sound outlet, and sound generated by the third speaker assembly is output through the first sound outlet and the second sound outlet.

The present disclosure provides a speaker module, which includes a first sound assembly (a first speaker assembly and a second speaker assembly) and a second sound assembly (a third speaker assembly and a fourth speaker assembly). The first sound assembly is configured to emit a first sound, and the second sound assembly is configured to emit a second sound. Since the design of the housing of the portable electronic device may vary according to user requirements, a phase difference may occur between the first sound emitted by the first sound assembly and the second sound emitted by the second sound assembly when reaching the human ear. In order to improve such a situation, the speaker module may be further provided with a second filter to compensate for the above phase difference.

The second filter may include a first impedance element to a fourth impedance element. When the phase difference between the first sound and the second sound is less than 0, the first impedance element and the second impedance element can be each configured to serve as a second inductor, and the third impedance element and the fourth impedance element can be each configured to serve as a second capacitor. On the other hand, when the phase difference is greater than 0, the first impedance element and the second impedance element can be each configured to serve as a second capacitor, and the third impedance element and the fourth impedance element can be each configured to serve as a second inductor.

Based on the configuration of the second filter of the present disclosure, no matter whether the phase difference between the first sound and the second sound is less than 0 or greater than 0, the second filter can effectively compensate to eliminate the phase difference. Therefore, the second sound can be effectively superimposed on the first sound in the low frequency range, so that the output performance of the low frequency can be enhanced, thereby maximizing the sound level heard by the user.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic three-dimensional diagram of a portable electronic device 1 according to an embodiment of the present disclosure.

FIG. 2 is a schematic three-dimensional diagram of the portable electronic device 1 in another view according to an embodiment of the present disclosure.

FIG. 3 is a schematic three-dimensional diagram of a speaker module 10 according to an embodiment of the present disclosure.

FIG. 4 is a three-dimensional diagram of a partial structure of the speaker module 10 according to an embodiment of the present disclosure.

FIG. 5 is a three-dimensional cross-sectional diagram of the portable electronic device 1 along line segment A-A in FIG. 1 according to an embodiment of the present disclosure.

FIG. 6 is a circuit diagram of the speaker module 10 according to an embodiment of the present disclosure.

FIG. 7 is a circuit diagram of the speaker module 10 when the phase difference between the first sound and the second sound is less than 0 according to an embodiment of the present disclosure.

FIG. 8 is a phase response curve diagram of the second filter 60 according to an embodiment of the present disclosure.

FIG. 9 is a chart illustrating the relationship between frequency and sound pressure level of the speaker module 10 under different configurations according to an embodiment of the present disclosure.

FIG. 10 is a circuit diagram of the speaker module 10 when the phase difference between the first sound and the second sound is greater than 0 according to another embodiment of the present disclosure.

FIG. 11 is a phase response curve diagram of the second filter 60 according to another embodiment of the present disclosure.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

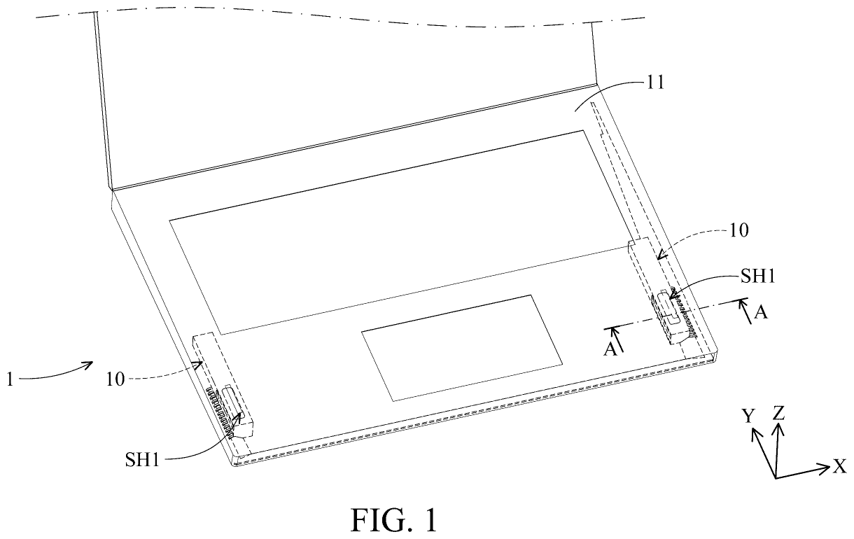

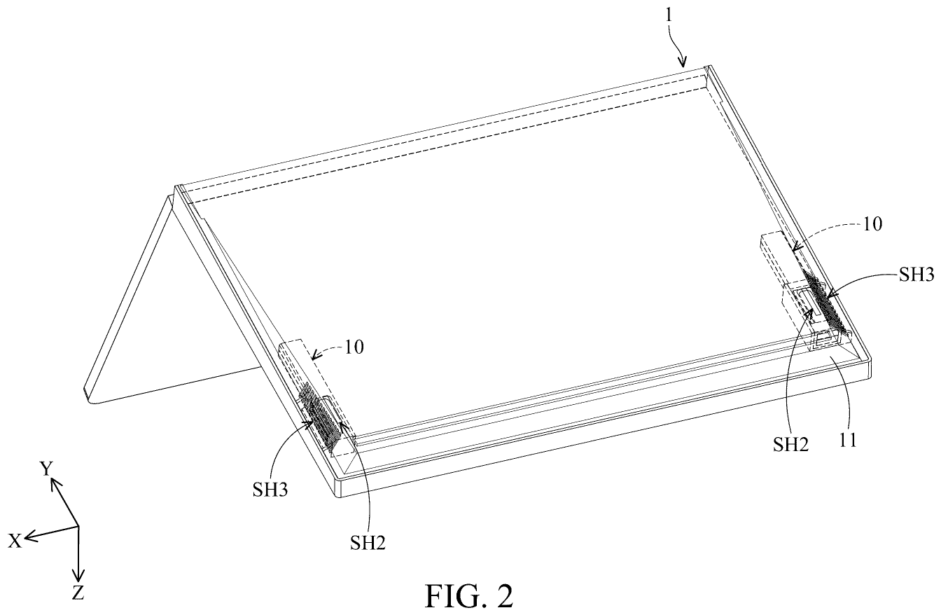

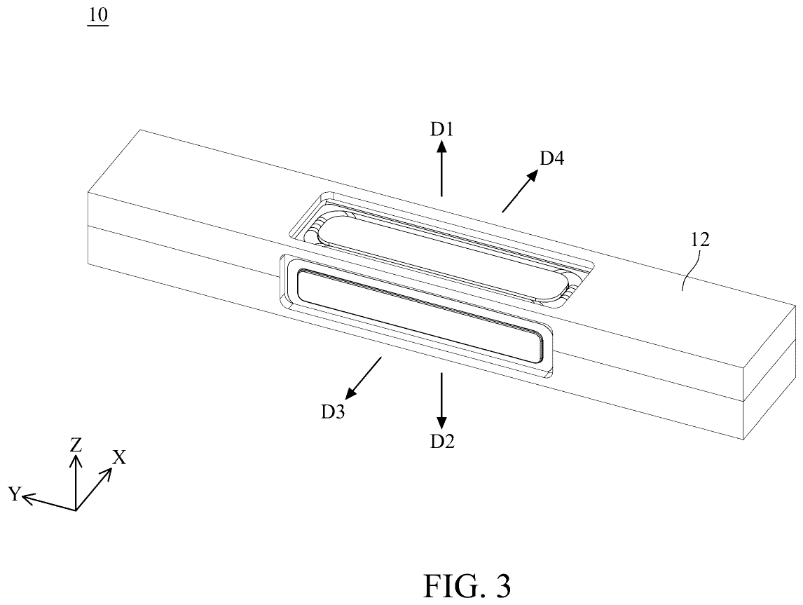

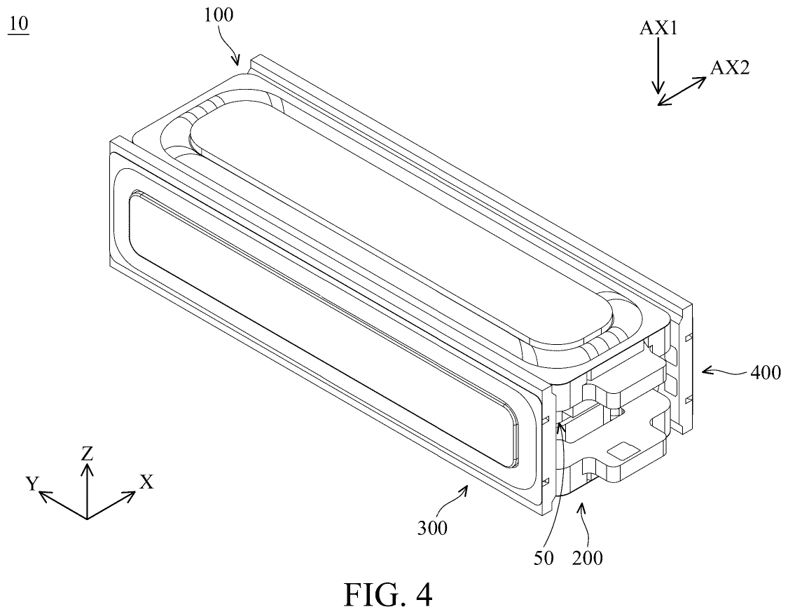

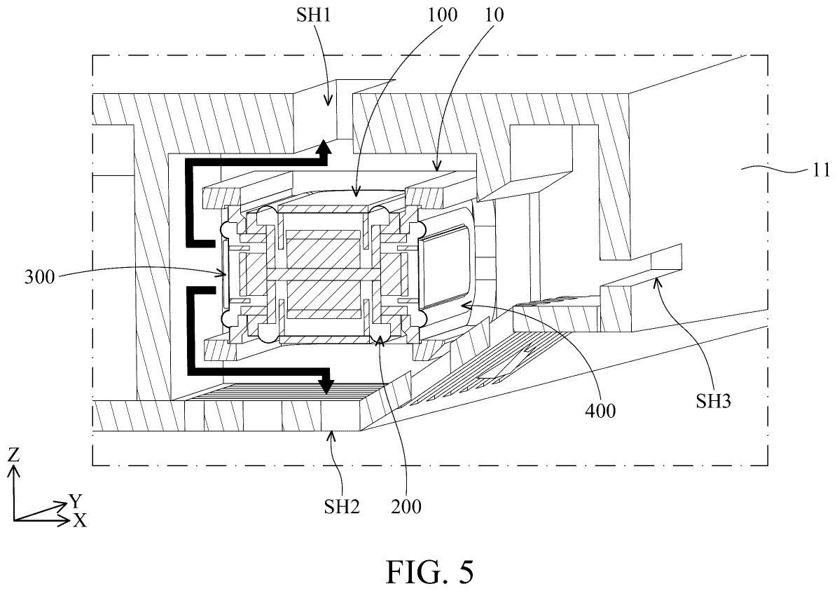

Please refer to FIG. 1 to FIG. 5. FIG. 1 is a schematic three-dimensional diagram of a portable electronic device 1 according to an embodiment of the present disclosure, FIG. 2 is a schematic three-dimensional diagram of the portable electronic device 1 in another viewing angle according to an embodiment of the present disclosure, FIG. 3 is a schematic three-dimensional diagram of a speaker module 10 according to an embodiment of the present disclosure, FIG. 4 is a three-dimensional diagram of a partial structure of the speaker module 10 according to an embodiment of the present disclosure, and FIG. 5 is a three-dimensional cross-sectional diagram of the portable electronic device 1 along line segment A-A in FIG. 1 according to an embodiment of the present disclosure.

In this embodiment, the portable electronic device 1 is a notebook computer including a housing 11, and the housing 11 may be equipped with two speaker modules 10, but the present disclosure is not limited thereto. The structures of the two speaker modules 10 are the same, so that the following paragraphs will only describe a single speaker module 10.

In this embodiment, as shown in FIG. 3 and FIG. 4, the speaker module 10 may include a casing 12, a base 50, a first speaker assembly 100, a second speaker assembly 200, a third speaker assembly 300, and a fourth speaker assembly 400. The first speaker assembly 100 and the second speaker assembly 200 may be collectively referred to as a first sound assembly, and the third speaker assembly 300 and the fourth speaker assembly 400 may be collectively referred to as a second sound assembly.

As shown in FIG. 3 and FIG. 4, the first speaker assembly 100, the second speaker assembly 200, the third speaker assembly 300, and the fourth speaker assembly 400 are disposed on the base 50, and the casing 12 is sleeved over these speaker assemblies. As shown in FIG. 3, four openings are disposed on the casing 12 so that the first speaker assembly 100, the second speaker assembly 200, the third speaker assembly 300, and the fourth speaker assembly 400 emit sound in a first direction D1, a second direction D2, a third direction D3, and a fourth direction D4, respectively.

As shown in FIG. 4, the first speaker assembly 100 and the second speaker assembly 200 are arranged along a first axis AX1 (the Z-axis), the third speaker assembly 300 and the fourth speaker assembly 400 are arranged along a second axis AX2 (the X-axis), and the first axis AX1 is perpendicular to the second axis AX2.

In this embodiment, the second speaker assembly 200 is symmetrical to the first speaker assembly 100, and the fourth speaker assembly 400 is symmetrical to the third speaker assembly 300. That is, the second speaker assembly 200 and the first speaker assembly 100 have the same component configuration, size, material, and parameters. Similarly, the fourth speaker assembly 400 and the third speaker assembly 300 also have the same component configuration, size, material, and parameters.

In addition, in this embodiment, the size of the first speaker assembly 100 is larger than the size of the third speaker assembly 300. For example, the first speaker assembly 100 has a length of 32 mm and a width of 9 mm, and the third speaker assembly 300 has a length of 32 mm and a width of 7 mm, but they are not limited thereto. Based on such a configuration, the height of the speaker module 10 along the Z-axis is relatively small, and thus can be applied to an ultra-thin notebook computer.

Based on the above design, when the first speaker assembly 100 and the second speaker assembly 200 receive current, the electromagnetic driving forces that drive the two diaphragms of the first speaker assembly 100 and the second speaker assembly 200 are the same in magnitude but opposite in direction, so that the base 50 is not affected by the electromagnetic driving forces. That is, the base 50 does not move along the Z-axis when the speaker module 10 emits sound.

Similarly, when the third speaker assembly 300 and the fourth speaker assembly 400 receive current, the electromagnetic driving forces drive the two diaphragms of the third speaker assembly 300 and the fourth speaker assembly 400 are the same in magnitude but opposite in direction, the base 50 is not affected by the electromagnetic driving forces. That is, the base 50 does not move along the X-axis when the speaker module 10 emits sound.

The detailed structural design and configuration of the speaker module 10 and the first speaker assembly 100 to the fourth speaker assembly 400 may be found in Taiwan Patent Application No. TW113125747, so that they are not described in detail herein.

Next, as shown in FIG. 1, FIG. 2 and FIG. 5, two first sound outlets SH1, two second sound outlets SH2 and two third sound outlets SH3 may be formed on the housing 11. The sound generated by the first speaker assembly 100 can be output through the corresponding first sound outlet SH1, the sound generated by the second speaker assembly 200 can be output through the corresponding second sound outlet SH2, the sound generated by the fourth speaker assembly 400 can be output through the corresponding third sound outlet SH3, and the sound generated by the third speaker assembly 300 can be output through the corresponding first sound outlet SH1 and the corresponding second sound outlet SH2 (as indicated by the arrows in FIG. 5).

In this embodiment, the first sound assembly is configured to emit a first sound (that is, a combined sound emitted by both the first speaker assembly 100 and the second speaker assembly 200). Specifically, the first sound assembly is configured to emit low frequency sound.

Furthermore, the second sound assembly is configured to emit a second sound (that is, a combined sound emitted by both the third speaker assembly 300 and the fourth speaker assembly 400). Specifically, the second sound assembly is configured to emit high frequency sound.

It should be noted that since the speaker module 10 can be installed in different models of portable electronic devices 1 (for example, different sizes or different shapes), that is, the design of the housing 11 may be different, a phase difference may occur between the first sound emitted by the first sound assembly and the second sound emitted by the second sound assembly when reaching the human ear.

Such a phase difference may cause the amplitudes of the first sound and the second sound to cancel each other out, resulting in a lower perceived sound by the user, which may not satisfy the user's usage experience. In order to improve such a situation, the speaker module 10 may further be provided with two filters to solve the above situation.

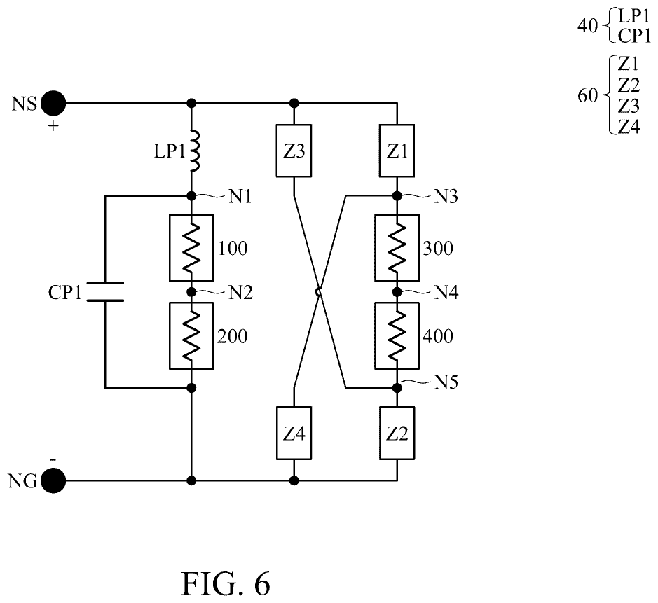

Please refer to FIG. 6, which is a circuit diagram of the speaker module 10 according to an embodiment of the present disclosure. In this embodiment, the first sound assembly and the second sound assembly are connected in parallel, and the speaker module 10 may further include a first filter 40 and a second filter 60.

The first filter 40 is connected to the first sound assembly and is configured to adjust the frequency range of the first sound. For example, in this embodiment, the first filter 40 may be a low-pass filter, and the cutoff frequency of the first filter 40 is less than or equal to 1 kHz, but it is not limited thereto.

The second filter 60 is connected to the second sound assembly and is configured to adjust the phase difference between the second sound and the first sound. For example, in this embodiment, the second filter 60 is an all-pass filter, which only changes the phase of the second sound but does not change the amplitude of the second sound.

As shown in FIG. 6, the first filter 40, the first speaker assembly 100 and the second speaker assembly 200 are electrically connected between a signal input node NS and a ground node NG, and the first filter 40 may include a first capacitor CP1 and a first inductor LP1.

The first inductor LP1 has a first terminal and a second terminal. The first terminal of the first inductor LP1 is coupled to the signal input node NS, and the second terminal of the first inductor LP1 is coupled to a first node N1.

The first speaker assembly 100 has a first terminal and a second terminal. The first terminal of the first speaker assembly 100 is coupled to the first node N1, and the second terminal of the first speaker assembly is coupled to a second node N2.

The second speaker assembly 200 has a first terminal and a second terminal. The first terminal of the second speaker assembly 200 is coupled to the second node N2, and the second terminal of the second speaker assembly 200 is coupled to the ground node NG.

The first capacitor CPT has a first terminal and a second terminal. The first terminal of the first capacitor CPT is coupled to the first node N1, and the second terminal of the first capacitor CPT is coupled to the ground node NG.

In addition, the second filter 60 may include a first impedance element Z1 to a fourth impedance element Z4. The first impedance element Z1 has a first terminal and a second terminal. The first terminal of the first impedance element Z1 is coupled to the signal input node NS, and the second terminal of the first impedance element Z1 is coupled to a third node N3.

The third speaker assembly 300 has a first terminal and a second terminal. The first terminal of the third speaker assembly 300 is coupled to the third node N3, and the second terminal of the third speaker assembly 300 is coupled to a fourth node N4.

The fourth speaker assembly 400 has a first terminal and a second terminal. The first terminal of the fourth speaker assembly 400 is coupled to the fourth node N4, and the second terminal of the fourth speaker assembly 400 is coupled to a fifth node N5.

The second impedance element Z2 has a first terminal and a second terminal, the first terminal of the second impedance element Z2 is coupled to the fifth node N5, and the second terminal of the second impedance element Z2 is coupled to the ground node NG.

The third impedance element Z3 has a first terminal and a second terminal, the first terminal of the third impedance element Z3 is coupled to the signal input node NS, and the second terminal of the third impedance element Z3 is coupled to the fifth node N5.

The fourth impedance element Z4 has a first terminal and a second terminal, the first terminal of the fourth impedance element Z4 is coupled to the third node N3, and the second terminal of the fourth impedance element Z4 is coupled to the ground node NG.

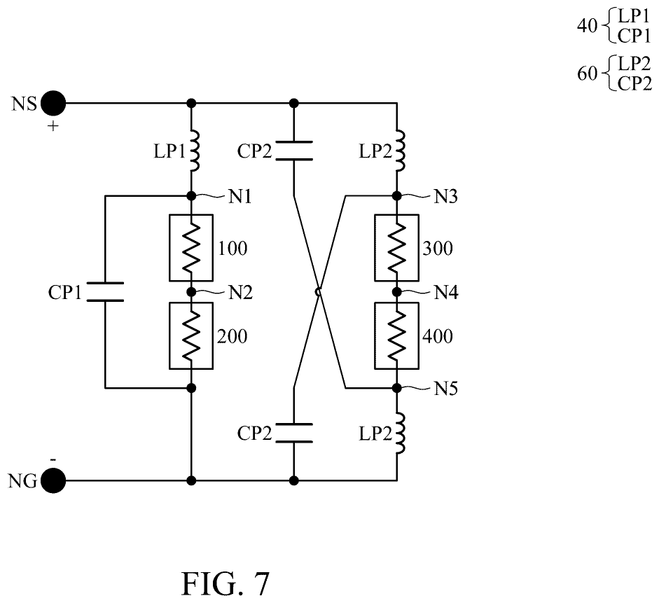

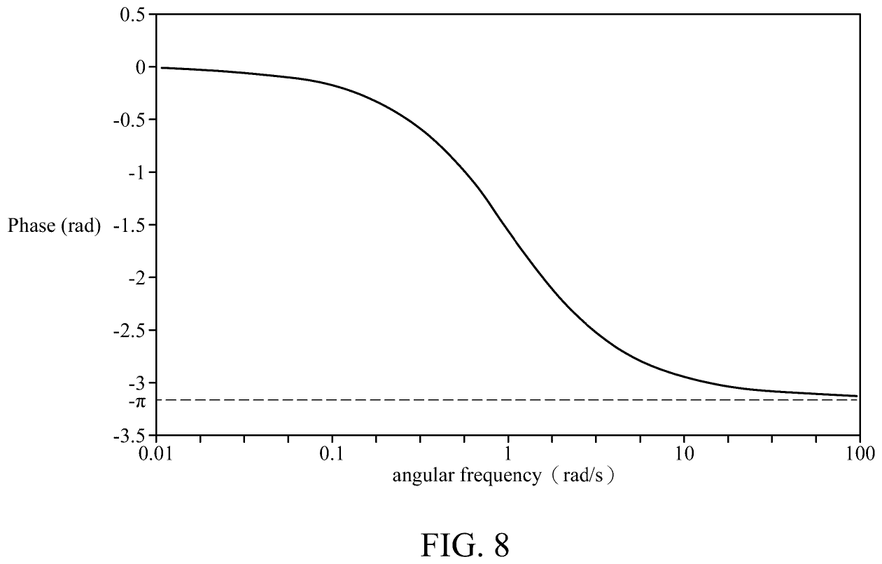

Please refer to FIG. 6 to FIG. 8 below. FIG. 7 is a circuit diagram of the speaker module 10 when the phase difference between the first sound and the second sound is less than 0 according to an embodiment of the present disclosure, and FIG. 8 is a phase response curve diagram of the second filter 60 according to an embodiment of the present disclosure. When the phase difference between the first sound and the second sound is less than 0, the first impedance element Z1 and the second impedance element Z2 can be each configured to serve as a second inductor LP2, and the third impedance element Z3 and the fourth impedance element Z4 can be each configured to serve as a second capacitor CP2.

Based on such a configuration, the phase response curve diagram of the second filter 60 can be obtained, as shown in FIG. 8. Therefore, in order to compensate for the actual phase difference, the values of the second inductor LP2 and the second capacitor CP2 in the second filter 60 can be obtained using the following formulas (1) and (2):

$$tan \frac{Δφ}{2} = - \frac{2 π \times {F}_{R}}{{ω}_{m}} \qquad ( 1 )$$

$${ω}_{m} = \frac{1}{\sqrt{{L}_{2} {C}_{2}}} \qquad ( 2 )$$

In the formulas, Δφ is the aforementioned phase difference, F_{R} is a reference frequency of the speaker module 10, Om is an angular frequency of the second filter 60, C₂ is a capacitance value of the second capacitor CP2, and L₂ is an inductance value of the second inductor LP2.

Next, the reference frequency can be further calculated using the following formula (3):

F_{R}=α×F_{LH}+(1−α)×F_{LPF} (3)

In the formula, F_R is the aforementioned reference frequency, F_{LH} is a transitional frequency of the speaker module 10, F_{LPF} is the cutoff frequency of the first filter 40, and α is an adjustment coefficient, which is greater than 0 and less than 1. For example, in this embodiment, a may be 0.5, but it is not limited thereto.

Then, the transitional frequency can be obtained using the following formula (4):

$${F}_{LH} = \frac{{P}_{H}}{{P}_{L} + {P}_{H}} \times {F}_{L} + \frac{{P}_{L}}{{P}_{L} + {P}_{H}} \times {F}_{H} \qquad ( 4 )$$

In the formula, F_{L} is a first resonant frequency of the first speaker assembly 100 and the second speaker assembly 200, F_{H} is a second resonant frequency of the third speaker assembly 300 and the fourth speaker assembly 400, P_{L} is a total power of the first speaker assembly 100 and the second speaker assembly 200 between the first resonant frequency and the second resonant frequency, and P_{H} is a total power of the third speaker assembly 300 and the fourth speaker assembly 400 between the first resonant frequency and the second resonant frequency.

It is worth noting that in order to effectively superimpose the second sound on the first sound in the low frequency range (such as below 1 kHz), the reference frequency is designed to be between the first resonant frequency and the cutoff frequency. For example, in this embodiment, the first resonance frequency may be 400 kHz, the second resonance frequency may be 700 kHz, the cutoff frequency may be 1 kHz, and the reference frequency may be 800 Hz, but they are not limited thereto.

Based on the above configuration and the formulas (1) to (4), appropriate and corresponding values of the second capacitor CP2 and the second inductor LP2 can be obtained in speaker module 10, so that second filter 60 can effectively reduce the phase difference between the first sound and the second sound. Therefore, the second sound can be effectively superimposed on the first sound in the low frequency range, so that the output performance of the low frequency can be enhanced.

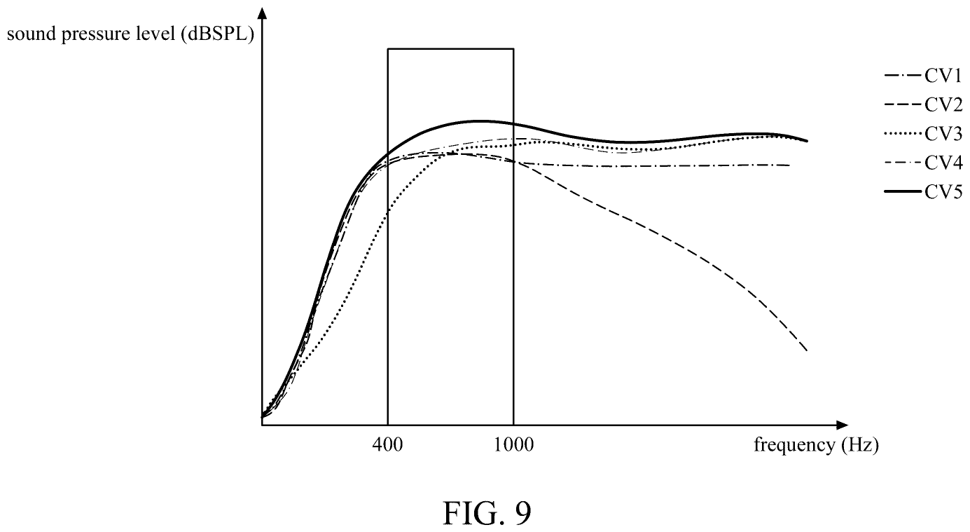

Specifically, please refer to FIG. 9. FIG. 9 is a chart illustrating the relationship between frequency and sound pressure level of the speaker module 10 under different configurations according to an embodiment of the present disclosure. In FIG. 9, the curve CV1 represents the sound pressure level curve of the first sound output by the first speaker assembly 100 and the second speaker assembly 200 at different frequencies, and the curve CV2 represents the sound pressure level curve of the first sound output by the first speaker assembly 100 and the second speaker assembly 200 with the first filter 40 at different frequencies.

Furthermore, the curve CV3 represents the sound pressure level curve of the second sound output by the third speaker assembly 300 and the fourth speaker assembly 400 at different frequencies, the curve CV4 represents the sound pressure level curve of the sound output by the speaker module 10 (including the first sound assembly and the second sound assembly) without the second filter 60 at different frequencies, and the curve CV5 represents the sound pressure level curve of the sound output by the speaker module 10 after the second filter 60 is added.

As shown in FIG. 9, compared to the curves CV1 to CV4, the curve CV5 exhibits a significant improvement in the sound pressure level in the low frequency range (such as 400 Hz to 1 kHz). For example, compared to the curve CV4, the curve CV5 shows an increase of more than 3 dB in the sound pressure level in the low frequency range.

Therefore, based on the configuration of the present disclosure, the sound pressure level of the speaker module 10 in low frequency range can be significantly improved, so that the output performance of the low-frequency sound can be effectively improved, and the low-frequency output volume can be louder.

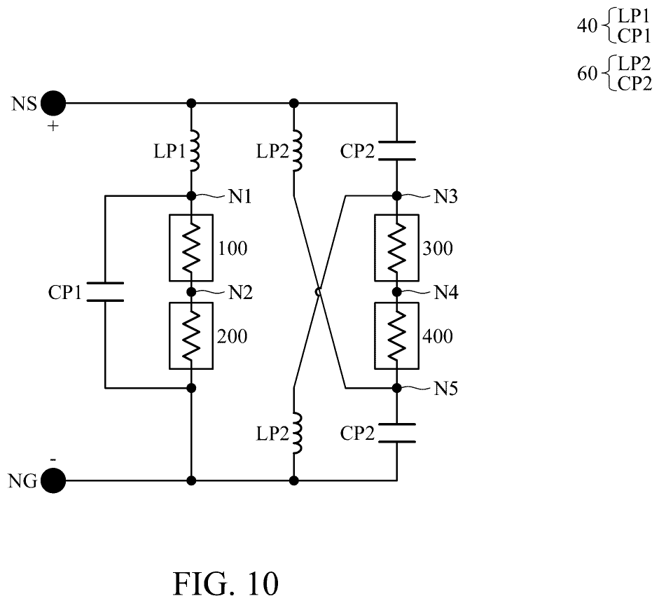

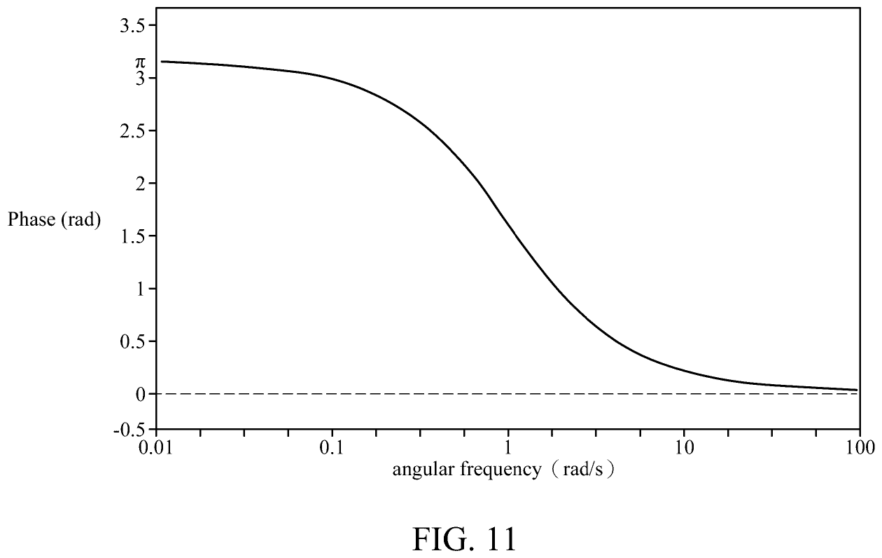

Please refer to FIG. 6, FIG. 10 and FIG. 11. FIG. 10 is a circuit diagram of the speaker module 10 when the phase difference between the first sound and the second sound is greater than 0 according to another embodiment of the present disclosure, and FIG. 11 is a phase response curve diagram of the second filter 60 according to another embodiment of the present disclosure. When the phase difference between the first sound and the second sound is greater than 0, the first impedance element Z1 and the second impedance element Z2 can be each configured to serve as a second capacitor CP2, and the third impedance element Z3 and the fourth impedance element Z4 can be each configured to serve as a second inductor LP2.

Based on such a configuration, the phase response curve diagram of the second filter 60 can be obtained, as shown in FIG. 11. Therefore, in order to compensate for the actual phase difference, the values of the second inductor LP2 and the second capacitor CP2 in the second filter 60 can be obtained according to the previous formulas (1) to (4).

Similar to the embodiments of FIG. 7 and FIG. 8, based on the above-mentioned design and formulas (1) to (4), appropriate and corresponding second capacitor CP2 and second inductor LP2 in the speaker module 10 can be obtained in this embodiment, so that the second filter 60 can effectively reduce the phase difference between the first sound and the second sound. Therefore, the second sound can be effectively superimposed on the first sound in the low frequency range, so that the output performance of the low frequency can be enhanced.

In conclusion, the present disclosure provides a speaker module 10, which includes a first sound assembly (a first speaker assembly 100 and a second speaker assembly 200) and a second sound assembly (a third speaker assembly 300 and a fourth speaker assembly 400). The first sound assembly is configured to emit a first sound, and the second sound assembly is configured to emit a second sound. Since the design of the housing 11 of the portable electronic device 1 may vary according to user requirements, a phase difference may occur between the first sound emitted by the first sound assembly and the second sound emitted by the second sound assembly when reaching the human ear. In order to improve such a situation, the speaker module 10 may be further provided with a second filter 60 to compensate for the above phase difference.

The second filter 60 may include a first impedance element Z1 to a fourth impedance element Z4. When the phase difference between the first sound and the second sound is less than 0, the first impedance element Z1 and the second impedance element Z2 can be each configured to serve as a second inductor LP2, and the third impedance element Z3 and the fourth impedance element Z4 can be each configured to serve as a second capacitor CP2. On the other hand, when the phase difference is greater than 0, the first impedance element Z1 and the second impedance element Z2 can be each configured to serve as a second capacitor CP2, and the third impedance element Z3 and the fourth impedance element Z4 can be each configured to serve as a second inductor LP2.

Based on the configuration of the second filter 60 of the present disclosure, no matter whether the phase difference between the first sound and the second sound is less than 0 or greater than 0, the second filter 60 can effectively compensate to eliminate the phase difference. Therefore, the second sound can be effectively superimposed on the first sound in the low frequency range, so that the output performance of the low frequency can be enhanced, thereby maximizing the sound level heard by the user.

In addition, in other embodiments, a control circuit may be further configured in the portable electronic device 1, and a plurality of second capacitors CP2 and second inductors LP2 may be disposed in the speaker module 10. The control circuit can control the circuit configuration of the speaker module 10 according to an input signal from a user or a sensing signal from a sensor. For example, the circuit of the speaker module 10 can be controlled to be implemented as shown in FIG. 7 or FIG. 10 to obtain the best sound output performance.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. A speaker module, comprising:
a base;
a first speaker assembly, disposed on the base and configured to emit a first sound;
a first filter, connected to the first sound assembly and configured to adjust the frequency range of the first sound;
a second speaker assembly, disposed on the base and configured to emit a second sound; and
a second filter, connected to the second sound assembly and configured to adjust a phase difference between the second sound and the first sound;
wherein the first sound assembly and the second sound assembly are connected to each other in parallel.

2. The speaker module as claimed in claim 1, wherein the first sound assembly includes a first speaker assembly and a second speaker assembly, and the second speaker assembly is symmetrical to the first speaker assembly;
wherein the second sound assembly includes a third speaker assembly and a fourth speaker assembly, and the fourth speaker assembly is symmetrical to the third speaker assembly.

3. The speaker module as claimed in claim 2, wherein the first speaker assembly and the second speaker assembly are arranged along a first axis, the third speaker assembly and the fourth speaker assembly are arranged along a second axis, and the first axis is perpendicular to the second axis.

4. The speaker module as claimed in claim 3, wherein the first filter, the first speaker assembly, and the second speaker assembly are electrically connected between a signal input node and a ground node, and the first filter includes a first capacitor and a first inductor;
the first inductor has a first terminal and a second terminal, the first terminal of the first inductor is coupled to the signal input node, and the second terminal of the first inductor is coupled to a first node.

5. The speaker module as claimed in claim 4, wherein the first speaker assembly has a first terminal and a second terminal, the first terminal of the first speaker assembly is coupled to the first node, and the second terminal of the first speaker assembly is coupled to a second node;
wherein the second speaker assembly has a first terminal and a second terminal, the first terminal of the second speaker assembly is coupled to the second node, and the second terminal of the second speaker assembly is coupled to the ground node.

6. The speaker module as claimed in claim 5, wherein the first capacitor has a first terminal and a second terminal, the first terminal of the first capacitor is coupled to the first node, and the second terminal of the first capacitor is coupled to the ground node.

7. The speaker module as claimed in claim 6, wherein the first filter is a low-pass filter, and a cutoff frequency of the first filter is less than or equal to 1 kHz.

8. The speaker module as claimed in claim 6, wherein the second filter comprises a first impedance element to a fourth impedance element;
the first impedance element has a first terminal and a second terminal, the first terminal of the first impedance element is coupled to the signal input node, and the second terminal of the first impedance element is coupled to a third node;
the third speaker assembly has a first terminal and a second terminal, the first terminal of the third speaker assembly is coupled to the third node, and the second terminal of the third speaker assembly is coupled to a fourth node.

9. The speaker module as claimed in claim 8, wherein the fourth speaker assembly has a first terminal and a second terminal, the first terminal of the fourth speaker assembly is coupled to the fourth node, and the second terminal of the fourth speaker assembly is coupled to a fifth node;
the second impedance element has a first terminal and a second terminal, the first terminal of the second impedance element is coupled to the fifth node, and the second terminal of the second impedance element is coupled to the ground node.

10. The speaker module as claimed in claim 9, wherein the third impedance element has a first terminal and a second terminal, the first terminal of the third impedance element is coupled to the signal input node, and the second terminal of the third impedance element is coupled to the fifth node;
the fourth impedance element has a first terminal and a second terminal, the first terminal of the fourth impedance element is coupled to the third node, and the second terminal of the fourth impedance element is coupled to the ground node.

11. The speaker module as claimed in claim 10, wherein when the phase difference is less than 0, the first impedance element and the second impedance element are each configured to serve as a second inductor, and the third impedance element and the fourth impedance element are each configured to serve as a second capacitor;
wherein values of the second inductor and the second capacitor are obtained using the following formula:
$$tan \frac{Δφ}{2} = - \frac{2 π \times {F}_{R}}{{ω}_{m}}$$
$${ω}_{m} = \frac{1}{\sqrt{{L}_{2} {C}_{2}}} ;$$
wherein, Δφ is the phase difference, F_{R} is a reference frequency of the speaker module, ωₘ is an angular frequency of the second filter, C₂ is a capacitance value of the second capacitor, and L₂ is an inductance value of the second inductor.

12. The speaker module as claimed in claim 11, wherein the reference frequency is obtained using the following formula:
F_{R}=α×F_{LH}+(1-α)×F_{LPF}
wherein, F_{R} is the reference frequency, F_{LH} is a transitional frequency of the speaker module, F_{LPF} is the cutoff frequency of the first filter, and α is an adjustment coefficient, which is greater than 0 and less than 1.

13. The speaker module as claimed in claim 12, wherein the transitional frequency is obtained using the following formula:
$${F}_{LH} = \frac{{P}_{H}}{{P}_{L} + {P}_{H}} \times {F}_{L} + \frac{{P}_{L}}{{P}_{L} + {P}_{H}} \times {F}_{H}$$
wherein, F_{L} is a first resonant frequency of the first speaker assembly and the second speaker assembly, F_{H} is a second resonant frequency of the third speaker assembly and the fourth speaker assembly, P_{L} is a total power of the first speaker assembly and the second speaker assembly between the first resonant frequency and the second resonant frequency, and P_{H} is a total power of the third speaker assembly and the fourth speaker assembly between the first resonant frequency and the second resonant frequency.

14. The speaker module as claimed in claim 10, wherein when the phase difference is greater than 0, the first impedance element and the second impedance element are each configured to serve as a second capacitor, and the third impedance element and the fourth impedance element are each configured to serve as a second inductor;
wherein values of the second inductor and the second capacitor are obtained using the following formula:
$$tan \frac{Δφ}{2} = - \frac{2 π \times {F}_{R}}{{ω}_{m}}$$
$${ω}_{m} = \frac{1}{\sqrt{{L}_{2} {C}_{2}}} ;$$
wherein, Δφ is the phase difference, F_{R} is a reference frequency of the speaker module, om is an angular frequency of the second filter, C₂ is a capacitance value of the second capacitor, and L₂ is an inductance value of the second inductor.

15. The speaker module as claimed in claim 14, wherein the reference frequency is obtained using the following formula:
F_{R}=α×F_{LH}+(1-α)×F_{LPF}
wherein, F_{R} is the reference frequency, F_{LH} is a transitional frequency of the speaker module, F_{LPF} is the cutoff frequency of the first filter, and a is an adjustment coefficient, which is greater than 0 and less than 1.

16. The speaker module as claimed in claim 15, wherein the transitional frequency is obtained using the following formula:
$${F}_{LH} = \frac{{P}_{H}}{{P}_{L} + {P}_{H}} \times {F}_{L} + \frac{{P}_{L}}{{P}_{L} + {P}_{H}} \times {F}_{H}$$
wherein, F_{L} is a first resonant frequency of the first speaker assembly and the second speaker assembly, F_{H} is a second resonant frequency of the third speaker assembly and the fourth speaker assembly, P_{L} is a total power of the first speaker assembly and the second speaker assembly between the first resonant frequency and the second resonant frequency, and P_{H} is a total power of the third speaker assembly and the fourth speaker assembly between the first resonant frequency and the second resonant frequency.

17. The speaker module as claimed in claim 16, wherein the reference frequency is between the first resonant frequency and the cutoff frequency.

18. A portable electronic device, comprising:
a housing; and
a speaker module, disposed in the housing and including:
a base;
a first speaker assembly, disposed on the base and configured to emit a first sound;
a first filter, connected to the first sound assembly and configured to adjust the frequency range of the first sound;
a second speaker assembly, disposed on the base and configured to emit a second sound; and
a second filter, connected to the second sound assembly and configured to adjust a phase difference between the second sound and the first sound;
wherein the first sound assembly and the second sound assembly are connected to each other in parallel.

19. The portable electronic device as claimed in claim 18, wherein the first sound assembly includes a first speaker assembly and a second speaker assembly, and the second speaker assembly is symmetrical to the first speaker assembly;
wherein the second sound assembly includes a third speaker assembly and a fourth speaker assembly, and the fourth speaker assembly is symmetrical to the third speaker assembly;
wherein a first sound outlet, a second sound outlet and a third sound outlet are formed on the housing, and the first sound outlet, the second sound outlet and the third sound outlet correspond to the first speaker assembly to the fourth speaker assembly.

20. The portable electronic device as claimed in claim 19, wherein the sound generated by the first speaker assembly is output through the first sound outlet, the sound generated by the second speaker assembly is output through the second sound outlet, sound generated by the fourth speaker assembly is output through the third sound outlet, and the sound generated by the third speaker assembly is output through the first sound outlet and the second sound outlet.
